(19) United States
(12) Patent Application Publication
(10) Pub. No.: US 2023/0313427 A1
(43) Pub. Date: Oct. 5, 2023

(54) INSULATION PRODUCT AND METHOD FOR MAKING INSULATION PRODUCT

(71) Applicant: INDUSTRIAL NATURE LTD., Edinburgh (GB)

(72) Inventor: Scott SIMPSON, Edinburgh (GB)

(21) Appl. No.: 17/927,066

(22) PCT Filed: May 24, 2021
(86) PCT No.: PCT/GB2021/051261

§ 371 Date: Nov. 22, 2022

(30) Foreign Application Priority Data
May 26, 2020 (GB) 2007818.4

(51) Int. Cl. D04H 1/4382; D21H 11/12

(52) U.S. Cl. CPC D04H 1/43835; D04H 1/43828; D21H 11/12

(57) ABSTRACT

Disclosed is an insulation product comprising hemp fibres bonded together using one or more biopolymers. Hemp fibres having lengths of between 5 and 100 mm amount to at least 50% by weight of the product. A hemp containing insulating batt or board may be made from opened hemp fibres, opened biopolymer binder fibres, mixing to produce a mixture in which the components are dispersed, air-laying the mixture, heating to above the melting point of the biopolymer binder fibres, forming to a desired thickness or density; and cooling

### FIELD OF THE INVENTION

The present invention relates to an insulation product and a method for making an insulation product. The product may be used in the construction industry and may have thermal and/or acoustic insulation properties.

### BACKGROUND TO THE INVENTION

The market for insulation products is dominated by materials which offer good thermal insulation properties but are made from non-renewable resources, require large amounts of energy for extraction and production which result in high embodied carbon footprints, and which at end of life end up in landfill.

There are alternative insulations made from renewable industrial crop fibres which have low embodied carbon but these have various disadvantages, some of which are a result of the use of petroplastic binders. In particular, lack of biodegradability can mean that they still end up in landfill at end of life.

Following research and development work by the present applicant, and the investigation of several types of product and method, further and improved innovative products and methods have now been found.

### SUMMARY OF THE INVENTION

According to a first aspect the present invention there is provided a product comprising hemp fibres (and optionally one or more other materials), bonded together using a biopolymer binder, wherein hemp fibres with lengths of between 5 and 100 mm amount to at least 50% by weight of the product.

The biopolymer binder, may be a biodegradable material. It may be broken down by natural organisms for example by microorganisms, fungi, or bacteria. It may be degradable using a composting method, suitably a hot composting method, i.e. one in which degradation occurs at higher than ambient temperatures e.g. higher than 45° C. The hot composting method uses heat and the presence of microorganisms and water. The degradable or decomposable nature of the biopolymer allows greater environmental benefit than has hitherto been the case with conventional insulation materials.

The biopolymer binder is derived from natural sources. It may be made from a natural product or a natural raw material.

The biopolymer binder may bond together the hemp fibres (and optionally other material) using thermobonding, i.e. by applying heat, for example in a thermobonding oven, to melt or soften the biopolymer and then by cooling (or allowing cooling to happen, e.g. by the removal of heat) to allow the biopolymer to harden and thereby bind the hemp fibres and optionally other material together.

Optionally the biopolymer binder has a melting point of below 200° C., e.g. below 180° C., e.g. below 160° C., e.g. below 150° C. Binders with low melting points are advantageous, in terms of cost and energy usage required for manufacture.

The biopolymer binder may also bond by chemical bonding, i.e. by covalently linking the fibres and optionally other materials together.

The biopolymer binder may comprise a single biopolymer, or more than one type of biopolymer. The biopolymer binder may comprise biopolymer having more than one melting point.

The skilled person will understand that a single type or class of polymer may be processed to provide different melting points, for example by virtue of the average molecular weight, amount of branching and so forth. Similarly, different polymers (of the same or different class) may have different melting points.

It may be that the product comprises only hemp fibres and biopolymer binder(s), i.e. consists of hemp fibres and biopolymer binder(s). Alternatively other materials may also be present, including other types of hemp material and/or material from plants other than hemp, e.g. fibres from plants other than hemp, and/or other material.

The other hemp material which may optionally be present may include other types of hemp material including shiv (also referred to in some documents as shives). Shiv differs from fibres in that it is the woody core material of hemp stalks. Hemp fibres can be removed from a hemp crop product by for example a process known as decortication. Decortication strips fibres, or “bast”, surrounding the woody core and said woody core may then be broken into pieces to provide a shiv material.

Decortication is a primarily mechanical process known to one skilled in the art. Various decortication process are known, but one example uses one or a series of interlocking fluted rollers to crush hemp stalks. In this process the shiv is broken into fragments and falls through the rollers and thereby separated from the fibrous bast.

The hemp fibres may be refined fibres. It may be that hemp fines and hemp dust are excluded or minimised, for example by a filter process. The exclusion, or substantial exclusion, of fines and dust, helps to ensure a fibrous product of low or medium density. The exclusion, or substantial exclusion, of fines and dust, also means that the product can be bound together effectively and cost-effectively. It may be that said other material(s) do not include hemp fines or hemp dust (i.e. the product may be substantially free of hemp fines or hemp dust, or the combination thereof), or do not include more than 5% by weight (of the product) of hemp fines or hemp dust. The product may include less than 5% by weight of hemp fines or hemp dust (or the combination thereof).

It will be understood that a product that is substantially free of hemp fines, hemp dust or the combination thereof may include small residual quantities of hemp fines and/or dust, such as for example less than 3%, 2%, 1%, 0.5% or 0.1% by weight of hemp fines, hemp dust or the combination thereof.

The hemp may be prepared by retting (e.g. typically allowing the hemp to mechanically degrade to some extent after cutting, e.g. letting the hemp lie on the ground after harvesting) followed by decorticating to separate the fibre from the shiv. Decortication may be effected using a decortication machine and/or by using a hammer mill.

It may be that, in the product, hemp fibres with lengths of between 5 and 100 mm amount to at least 40% by weight of the product. It may be that, in the product, hemp fibres with lengths of between 5 and 70 mm amount to at least 40% by weight of the product. It may be that, in the product, hemp fibres with lengths of between 30 and 70 mm amount to at least 40% by weight of the product. It may be that, in the product, hemp fibres with lengths of between 40 and 60 mm amount to at least 40% by weight of the product.

It may be that, in the product, hemp fibres with lengths of between 5 and 100 mm amount to at least 50% by weight of the product. It may be that, in the product, hemp fibres with lengths of between 5 and 70 mm amount to at least 50% by weight of the product. It may be that, in the product, hemp fibres with lengths of between 30 and 70 mm amount to at least 50% by weight of the product. It may be that, in the product, hemp fibres with lengths of between 40 and 60 mm amount to at least 50% by weight of the product.

It may be that, in the product, hemp fibres with lengths of between 5 and 100 mm amount to at least 70% by weight of the product. It may be that, in the product, hemp fibres with lengths of between 5 and 70 mm amount to at least 70% by weight of the product. It may be that, in the product, hemp fibres with lengths of between 30 and 70 mm amount to at least 70% by weight of the product. It may be that, in the product, hemp fibres with lengths of between 40 and 60 mm amount to at least 70% by weight of the product.

It may be that, in the product, hemp fibres with lengths of between 5 and 100 mm amount to at least 80% by weight of the product. It may be that, in the product, hemp fibres with lengths of between 5 and 70 mm amount to at least 80% by weight of the product. It may be that, in the product, hemp fibres with lengths of between 30 and 70 mm amount to at least 80% by weight of the product. It may be that, in the product, hemp fibres with lengths of between 40 and 60 mm amount to at least 80% by weight of the product.

It may be that, in the product, hemp fibres with lengths of between 5 and 100 mm amount to at least 85% by weight of the product. It may be that, in the product, hemp fibres with lengths of between 5 and 70 mm amount to at least 85% by weight of the product. It may be that, in the product, hemp fibres with lengths of between 30 and 70 mm amount to at least 85% by weight of the product. It may be that, in the product, hemp fibres with lengths of between 40 and 60 mm amount to at least 85% by weight of the product.

The product may contain plant or crop material (e.g. fibres) other than hemp material. For example, when hemp fibres with lengths of between 5 and 100 mm (or between 5 and 70 mm, or between 30 and 70 mm, or between 40 and 60 mm) amount to at least 40% by weight of the product, then other plant material may amount to at least 30% (e.g. at least 40%, e.g. at least 50%) by weight of the product. For example, when hemp fibres with lengths of between 5 and 100 mm (or between 5 and 70 mm, or between 30 and 70 mm, or between 40 and 60 mm) amount to at least 60% by weight of the product, then other plant material may amount to at least 10% (e.g. at least 20%, e.g. at least 30%) by weight of the product. For example, when hemp fibres with lengths of between 5 and 100 mm (or between 5 and 70 mm, or between 30 and 70 mm, or between 40 and 60 mm) amount to at least 70% by weight of the product, then other plant material may amount to at least 10% (e.g. at least 20%) by weight of the product.

The hemp fibres, or at least some of them, are between 5 and 100 mm long. It may be that 90% by weight of the fibres are less than 70 mm.

Optionally hemp fibres of such lengths amount to at least 50% by weight of the product, or at least 60% by weight of the product, or at least 70% by weight of the product, or at least 80% by weight of the product, or at least 90% by weight of the product, or at least 95% by weight of the product, or at least 98% by weight of the product, or at least 99% by weight of the product, or at least 99.5% by weight of the product.

An alternative way of quantifying the content of hemp fibres is in terms of the fraction of the material used, before addition of the biopolymer binder. Thus, optionally, hemp fibres of the lengths defined above (i.e. between 5 and 100 mm, between 5 and 70 mm, between 30 and 70 mm or between 40 and 60 mm) may amount to at least 60%, 70%, 80%, 90%, 95%, 98%, 99%, or 99.5% by weight, or may amount to 100% by weight, of the material which is bound by the biopolymer binder.

Optionally, hemp fibres of the lengths defined above may amount to at least 60%, 70%, 80%, 90%, 95%, 98%, 99%, or 99.5% by weight, or may amount to 100% by weight, of the crop material or plant material used in the product and which is bound by the biopolymer binder.

Optionally, hemp fibres of the lengths defined above may amount to at least 60%, 70%, 80%, 90%, 95%, 98%, 99%, or 99.5% by weight, or may amount to 100% by weight, of the hemp fibres, or of the hemp material used in the product and which is bound by the biopolymer binder.

Optionally at least 50% or at least 75% or at least 90% or at least 95% or 100% by weight of the hemp shiv which is optionally included may comprise fragments in which the largest dimension is no greater than 30 mm, or no greater than 20 mm, or no greater than 10 mm, or no greater than 5 mm.

Optionally the product may comprise additional plant or crop material (i.e. plant or crop material in addition to the hemp material).

The additional crop or plant material may comprise flax, sheep’s wool, cotton and/or woodfibre. The additional crop or plant material may be selected to provide a suitable thermal performance, density or other material property. For example, in some embodiments, the additional crop or plant material can result in increased thermal performance. Such other material may be blended with the hemp fibres, for example making up to 50% of the crop fibre blend.

The ratio of hemp material to additional crop or plant material may be within the range of 75:25 to 99:1, e.g. 80:20 to 90:10, by weight. The ratio of hemp:additional crop/plant material may be within the range 75:25 to 25:75, or 60:40 to 40:60. For example, the ratio of help: additional crop/plant material may in some embodiments be around 50:50

The additional plant or crop material may comprise flax material, for example flax fibres and/or flax shiv and/or flax fines. The dimensions of these may be the same as those relating to hemp. Suitably the ratio of hemp to flax materials may be within the range of 75:25 to 99:1, e.g. 80:20 to 90:10, by weight. The ratio of hemp:flax may be within the range 75:25 to 25:75, or 60:40 to 40:60. For example, the ratio of help:flax may in some embodiments be around 50:50.

Other crop materials may have different or complimentary thermal or mechanical properties to hemp. Flax, for example, can be made into a fibrous material in which the fibres are generally finer (smaller diameter) and more flexible than hemp fibres. It has been found that flax fibres can integrate within the hemp fibre and binder matrix, such that the use of flax fibres has been shown in some circumstance to improve thermal performance, while maintaining good mechanical properties associated with the hemp fibres. Thermal conductivity may be reduced by between around 0.001 to 0.005 W/mK, or by between around 0.002 to 0.004 W/mK, or by around 0.003 W/mK.

Optionally other material or components may also be included, for example fire retardant fibres (e.g. in an amount of up to 2% or up to 1% by weight of the product).

Fire-retardant properties may alternatively, or in addition, be provided by treatment with a fire retardant composition. A fire retardant composition may be provided as a coating on at least a portion of the help fibres and/or biopolymer binder (and any other fibre of material present). For example, in some embodiments, ammonium sulphate solution, a boric acid solution or an aluminium hydroxide solution is applied at one or more stages of manufacture. Fibres, for example hemp fibres, can be sprayed with a fire retardant solution and optionally dried. Such treatment may be conducted at multiple stages of manufacture, for example before and after mixing with binder.

The product of the present invention has been found to exhibit favourable properties. In particular:

1. Friability is limited and material cohesion is optimised (i.e.: the product does not crumble or fall apart when handled and installed).

2. The product resists slumping after being installed - this is important for insulation.

3. The product can be cut easily by the installer - fibres that are too long make this difficult.

4. Apparatus is able to handle this range of fibre and shiv sizes and ratios

5. The thermal performance of the product is optimised.

6. The presence of shiv in certain types of product (for example, insulating board rather than insulating batts or rolls) adds rigidity. It will be understood however that use of shiv may also be advantageous for certain insulating batt applications.

7. The products have proven to be durable - as tested in a climate chamber.

One class of suitable products in accordance with the present invention is that of relatively low density insulating batts.

Thus the present invention provides a product in accordance with the first aspect defined above, wherein hemp fibres of the lengths defined above may amount to at least 95%, 98%, 99%, or 99.5% by weight, or may amount to 100% by weight, of the hemp material used in the product and which is bound by the biopolymer binder. The hemp fibres may amount to at least 90%, 95%, 98%, 99%, or 99.5% by weight, or may amount to 100% by weight, of the material which is bound by the biopolymer binder. Optionally the product may have a density of 10 kg/ m³ to 100 kg/ m³, or 20 kg/ m³ to 80 kg/ m³, or 40 kg/ m³ to 60 kg/ m³.

The product may be an insulating building material. By insulating building material we include insulating building materials for use in new or existing buildings, such as insulating batts, rolls, panels or boards; for lining a wall, roof or ceiling, or for filling a cavity in a wall, roof or ceiling.

Typically, materials may be combined in this process to produce low-density insulating ‘flexi’ batts or rolls for thermal and / or acoustic insulation purposes such as in construction. They may typically contain only crop and biopolymer and no hemp shivs.

Another class of suitable products in accordance with the present invention is that of relatively high density insulating boards.

Thus the present invention provides a product in accordance with the first aspect defined above, wherein hemp fibres of the lengths defined above may amount to between 60% and 95%, or between 70% and 90%, or between 80% and 85%, by weight, or may amount to 100% by weight, of the hemp material used in the product and which is bound by the biopolymer binder, and/or wherein hemp shiv may amount to at least 5%, or at least 10%, or at least 15%, or at least 20%, or at least 25%, or at least 30%, or at least 35%, by weight, of the hemp material used in the product and which is bound by the biopolymer binder. Optionally the product may have a density of 100 kg/ m³ to 200 kg/ m³, or 120 kg/ m³ to 180 kg/ m³, or 140 kg/ m³ to 160 kg/ m³, or 140 kg/ m³ to 150 kg/ m³.

Materials may be combined in this process to produce medium-density semirigid, non-structural insulating boards for thermal or acoustic insulation purposes such as in construction. The density may range from 100 kg/m³ to 200 kg/m³ . They may include significant quantities of shiv, for example in a blend ratio by weight of up to 45% hemp shiv, e.g. when up to 45% hemp fibre is used - the remaining part being a thermobonding biopolymer fibre.

Each of these two types of product may be used independently during building construction, or products may also be used together. Furthermore in accordance with the present invention composite products may comprise the batts and boards together.

The products of the present invention may be provided with facings or linings on one or more surface.

The products of the present invention may be planar or flat structures.

The flexi batts may be friction fitted within voids in building frameworks (e.g. in cavities or between studs, joists or rafters). They can be applied to most building types and either in a new build or as a retrofit measure.

Thicknesses may in some cases range from 50 mm to 300 mm, with dimensions suitable for various structural requirements.

They may be available as either flexible ‘batts’ or as rolls.

The medium-density insulating boards may be fixed (e.g. with screws) to a building’s framework - with the ability to be applied to most building types and either in a new build or as a retrofit measure.

Thicknesses may range from 10 mm to 100 mm.

The thickness of the products may optionally be between 5 mm and 200 mm, or between 30 mm and 150 mm, or between 50 mm and 75 mm.

One suitable thickness range, particularly for lower density products, is 40 to 200 mm, or 50 to 140 mm, or 80 to 120 mm.

Another suitable thickness range, particularly for higher density products, is 5 to 120 mm, or 40 to 100 mm, or 60 to 80 mm.

The products exhibit excellent thermal insulation. The thermal conductivity of the materials may for example range from 0.030W/m.K to 0.045W/m.K. The products furthermore exhibit excellent acoustic insulation.

The biopolymer binder used may be a polymer, resin or plastic which can act as a binder, i.e. can bond together the hemp fibres and optional other materials present. The binder may be a material which bonds the materials together by thermobonding.

Suitable binders include polyesters. These can be degradable under certain conditions. Particularly advantageous are polyesters which may be obtainable by sustainable routes. They may be biosynthesised or bioengineered from natural products using fermentation and other methods. Suitable polyesters include polylactic acid (PLA), polybutylene succinate (PBS) or polyhydroxyalkanoates (PHAs), amongst others.

Other suitable types of binder are lignin-based binders. These can include phenolic polymers, lignosulphonates (e.g. calcium lignosulphonates) and lignin (e.g. kraft lignin). They have the advantage of sustainable production from natural materials.

The biopolymer binder may be added to the hemp fibres and/or additional hemp material and/or plant or crop material (where present) in powdered form, as solution (e.g. by spraying) or in a biopolymer fibre form, or a combination thereof.

The plant/crop fibres may be bound together directly by the biopolymer binder (i.e. to form intersections between plant/crop fibres or shivs, for example) and/or multiple plant/crop fibres may be bound to a biopolymer fibre, along its length.

The biopolymer binder may comprise between around 1 and 50% by weight of the product, or between around 1% and 25%, or between around 5% and 25%, or between around 5%-15% by weight of the product, or around 5, 10%, 15% or around 20% by weight of the product. The biopolymer binder may comprise between around 10%-50%, or between around 15%-45%, between around 20%-40% by weight of the product. The biopolymer binder may comprise around 20%, 20% or 40% by weight of the product. It will be understood that the amount of binder by weight of the product will be selected for a particular purpose. An insulating board may comprise a higher weight percentage of binder than an insulating batt, for example.

For the purpose of thermobonding the natural fibre materials the binder may be in the form of bicomponent (or “bico”) polymer fibres, which include a core with a higher melting temperature than the sheath.

The product may be incorporated into a constructed object, such as a building or a vehicle. The constructed object may comprise a material or object for use in a building, such as a wall or ceiling panel. The product may be incorporated into other constructed objects where heat management is beneficial, such as furniture, mattresses and the like.

According to a second aspect the present invention provides a method of making a product, such as a hemp-containing insulating batt or board, the method comprising the steps of:
Providing opened hemp fibres, and biopolymer binder;
Mixing the hemp fibres and biopolymer binder to produce a mixture in which the components are dispersed;
Air-laying the mixture to form a layer;
Heating the mixture to bind at least a proportion of the hemp fibres together with the biopolymer binder;
Forming the layer to a desired thickness or density; and
Cooling the layer or allowing it to cool.

The biopolymer binder may comprise biopolymer fibre, such as bico fibre. The method may comprise providing opened biopolymer fibre.

The biopolymer binder may comprise biopolymer powder. The method may comprise mixing biopolymer powder with the hemp fibre.

The method may comprise heating the biopolymer binder to soften or at least partially melt the biopolymer binder and thereby bind the hemp fibres. The method may comprise chemically bonding the biopolymer binder and hemp fibres.

The method may comprise heating biopolymer fibres above a melting point of the biopolymer fibres to melt or partially melt said biopolymer fibres.

The components used in this method and their relative amounts may optionally be as defined above in relation to the first aspect. The method may comprise making a product in accordance with the first aspect.

Said method uses opened fibres. These may be produced by a step, typically using mechanical openers, which loosens and breaks apart bales or other forms of the product (in which form the product may have conveniently been transported) to form loose fibres.

Said method provides separate components (hemp fibres, biopolymer binder fibres and optionally other materials). These may be dosed into and combined from individual hoppers

Said method includes a mixing step in which the components are mixed thoroughly to provide a fully dispersed mixture, before an air-laying step.

The mixing may be carried out after individual components have been opened, or alternatively or additionally mixing may take place concomitantly with opening.

One or more conveyor may be used to transport the material during the method.

Spiked cylinders may be used along the process to open and blend the fibres.

The mixture may be pneumatically or mechanically transported to an air-lay unit. The mixture is air-laid to form a layer in the form of a uniform slab or ‘matt’. In an air-laying process, the mixed material is fed by conveyor on to the surface of a rotating carding cylinder. The carding cylinder is typically provided with a sawtooth surface, or an array of pins or protrusions on the outer surface, for opening, or further opening, the mixed fibrous material (the opening achieved by varying the rotating speed of the card cylinder in comparison to the conveyor speed). The material slab is removed from the cylinder by an air flow between the cylinder surface and the material slab.

The air-laying step is advantageous in facilitating a low density matt of fibres which is well-mixed, of a suitable form and easily processed. The layer is heated, optionally by transporting said layer on a conveyor through a thermobonding oven. Suitably, the layer may be compacted at the same time or subsequently, to assist with the bonding of the material and to achieve desired thickness and density.

Compaction may be by means of additional belt compression, for example within the thermobonding oven.

The density may be influenced and tailored by not only the compacting carried out but also by the components present.

Thus an airlay non-woven machine may be used rather than a lapping machine.

We have observed that natural bast fibres (such as hemp) are relatively brittle and require soft handling in machinery. In some embodiments, the airlay machine uses one or more rollers with pins on the outer surface to open the fibres. An array of pins has been found to be more mechanically gentle than, for example, carding wire (strips extending across the cylinder surface with a “saw tooth” profile or other sharpened array). The fibres may thereby suffer less mechanical damage during an airlay process. An airlay process using an array of pins on the carding cylinder to open the fibres may also produce less dust, which means the materials bind together better and there is an improved air quality for the health of machine operators. A further consequence is that the machines need less maintenance as the pins are typically more durable.

The method may comprise use of further optional materials disclosed herein in relation to the first aspect. The skilled person will understand that the additional materials, such as hemp shiv or additional plant or crop material, may be added in any suitable order or amount as disclosed herein. The method may accordingly comprise one or more steps of mixing, melting, spraying coating and the like to arrive at a dispersed mixture suitable for forming into the product.

The invention extends in further aspects to product obtainable by the method of the second aspect, and to the use of a product in accordance with the first aspect for insulation, for example in a vehicle or a building.

### DETAILED DESCRIPTION OF EXAMPLE EMBODIMENTS

Non-limiting example embodiments will now be described.

### Example 1

Thermal insulation batts were manufactured by the methods disclosed herein.

Polylactic acid (PLA) fibre binder (such as Ingeo™ Biopolymer 6302D ) and hemp fibres were each provided in the form of bales. Hemp crops had been cut, retted in the field, harvested into bales then separated into fibres and shives using a decortication mill to lengths of between 10-70 mm and then dust removed by mechanical filters before fibres were baled and shives packaged in bags. The relatively compressed fibre bales were fed into hoppers, dosed by weight and the fibres were then opened in mechanical opening machines and mixed to form a dispersed mixture within an airlay apparatus to achieve the desired density and product thickness prior to entering the oven

The mixture then exited the airlay apparatus as a matt layer, and was conveyed through an oven, with additional compression via a double belt system and heated to a temperature of between 120 - 160° C.] to partially melt or soften the biopolymer fibres and cause binding between the biopolymer fibres and the hemp fibres.

An optional step of forming is provided to produce insulating batts of required thickness or density. This forming step was conducted prior to and during cooling.

The resulting material was then cooled and its physical properties tested using standard industry methods.

### Durability

Durability was tested by exposing the batts to high temperatures of up to 60° C. and high relative humidity, over 75%, in a climate chamber for 5 days.

No physical changes were observed following exposure to these conditions and the product’s thermal performance remained unchanged. The insulating batts were found to meet the requirements of British Standard BS 5250:2011+A1:2016 “Code of practice for control of condensation in buildings”.

### Thermal Conductivity

Thermal conductivity was measured by the methods set out in ISO 9869 -1:2014, “Thermal insulation - Building elements - In-situ measurement of thermal resistance and thermal transmittance - Part 1: Heat flow meter method”.

Thermal conductivity of the insulating batts was found to be 0.038 W/mK. The insulating batts were found to meet the requirements of British Standard BS ISO 9869 - 1:2014.

### Vapour Permeability

Vapour permeability was measured in accordance with the methods set out in ISO 12572:2001.

Vapour permeability of the insulating batts was found to be 2µ. The insulating batts were found to meet the requirements of British Standard BS 5250:2011+A1:201.

### Density

Bulk density of the insulating batts was found to be 45 kg/m³.

### Specific Heat Capacity

An estimate of the specific heat capacity was made by comparison of required electrical heat energy input required to raise the temperature of the insulating batts by a known amount above ambient temperature, to the heat input required to raise the temperature of a commercially available insulation product of known specific heat capacity.

Specific heat capacity was estimated to be 2100 J/(kg.K).

### Example 2

Thermally and acoustically insulating boards were manufactured by the methods disclosed herein.

Polylactic acid (PLA) fibre binder (such as Ingeo™ Biopolymer 6302D ) and hemp fibres were each provided in the form of bales. Hemp crops had been cut, retted in the field, harvested into bales then separated into fibres and shives using a decortication mill to lengths of between 10-70 mm and then dust removed by mechanical filters before fibres were baled and shives packaged in bags. The relatively compressed fibre bales were fed into hoppers, dosed by weight and the fibres were then opened in mechanical opening machines and mixed to form a dispersed mixture within an airlay apparatus to achieve the desired density and product thickness prior to entering the oven.

In addition, hemp shives were added via a hopper at between 30-50% by weight of the total material weight

The mixture then exited the airlay apparatus as a matt layer, and conveyed through an oven, with significant additional compression via a double belt system and heated to a temperature of between 120 - 160° C. to partially melt or soften the biopolymer fibres and cause binding between the biopolymer fibres and the hemp fibres. The resulting material was then cooled.

Bulk density of the insulating boards was found to be 140 kg/m³.

Specific heat capacity was estimated to be 2100 J/(kg.K).

Acoustic Performance was estimated by comparison to commercially available products of known acoustic performance. The acoustic absorption coefficient α of the insulating boards was estimated to be 0.75.

1. A product comprising hemp fibres, bonded together using a biopolymer binder, wherein hemp fibres with lengths of between 5 and 100 mm amount to at least 50% by weight of the product.

2. A product as claimed in claim 1, wherein said biopolymer binder is biodegradable.

3. A product as claimed in claim 1,wherein said biopolymer binder has a melting point of below 180° C.

4. A product as claimed in claim 1,wherein the biopolymer binder is in the form of biopolymer fibres.

5. A product as claimed in claim 1, wherein the biopolymer binder comprises two or more biopolymers and/or biopolymer or biopolymers having two or more melting points.

6. A product as claimed in claim 5, wherein the biopolymer binder comprises biopolymer fibre having a core with a higher melting point than an outer sheath of each fibre.

7. A product as claimed in claim 1,wherein the product further comprises hemp shiv.

8. (canceled)

9. A product as claimed in claim 1, wherein hemp fibres with lengths of between 40 and 60 mm amount to at least 40% by weight of the product.

10. A product as claimed in claim 1, wherein the product contains plant or crop material other than hemp material and wherein the additional plant or crop material amounts to at least 10% by weight of the product.

11. A product as claimed in claim 10, wherein the additional plant or crop material comprises flax material, wherein the ratio of hemp material to flax material is in the range between 75:25 to 25:75.

12. A product as claimed in claim 1, wherein said hemp fibres amount to at least 70% by weight of the crop material or plant material used in the product.

13. A product as claimed in claim 1, in the form of an insulating batt, wherein hemp fibres of the lengths 30 to 70 mm amount to at least 95% by weight of the hemp material used in the product and which is bound by the biopolymer binder, wherein hemp fibres of the lengths 30 to 70 mm amount to at least 90% by weight of the material which is bound by the biopolymer binder, and wherein the product has a density of 10 kg/ m³ to 100 kg/ m³.

14. A product as claimed in claim 1, in the form of an insulating board, wherein hemp fibres of the lengths 30 to 70 mm amount to between 60% and 95% by weight of the hemp material used in the product and which is bound by the biopolymer binder, wherein hemp shiv amounts to at least 5% by weight, of the hemp material used in the product and which is bound by the biopolymer binder, and wherein the product has a density of 100 kg/ m³ to 200 kg/ m3.

15. A product as claimed in claim 1, wherein the biopolymer binder comprises one or more polyester or lignin-based biopolymers.

16. (canceled)

17. A method of making a product according to claim 1, comprising the steps of:
Providing opened hemp fibres and biopolymer binder;
Mixing the hemp fibres and biopolymer binder to produce a mixture in which the components are dispersed;
Air-laying the mixture to form a layer;
Heating the mixture to bind at least a proportion of the help fibres together with the biopolymer binder;
Forming the layer to a desired thickness or density; and
Cooling the layer or allowing it to cool.

18. (canceled)

19. The method of claim 17, comprising heating the biopolymer binder to soften or at least partially melt the biopolymer binder and thereby bind the hemp fibres.

20. A method as claimed in claim 17, wherein spiked cylinders are used to open and blend the said fibres.

21. (canceled)

22. A method as claimed in claim 17, in which the mixture is air-laid to form a layer in the form of a uniform slab.

23. A method as claimed in claim 22, further transporting said layer on a conveyor through a thermobonding oven.

24. (canceled)

25. Use of a product as claimed in claim 1 for insulation.
